(19) United States
(12) Patent Application Publication
(10) Pub. No.: US 2013/0271680 A1
(43) Pub. Date: Oct. 17, 2013

(54) LIQUID CRYSTAL PANEL, AND LIQUID CRYSTAL DISPLAY

(71) Applicants: Mitsuhiro Murata, Osaka-shi (JP); Yosuke Iwata, Osaka-shi (JP)

(72) Inventors: Mitsuhiro Murata, Osaka-shi (JP); Yosuke Iwata, Osaka-shi (JP)

(73) Assignee: SHARP KABUSHIKI KAISHA, Osaka-shi, Osaka (JP)

(21) Appl. No.: 13/976,723

(22) PCT Filed: Dec. 21, 2011
(86) PCT No.: PCT/JP2011/079721

§ 371 Date: Jun. 27, 2013

(30) Foreign Application Priority Data
Dec. 28, 2010 (JP) 2010-293847

(51) Int. Cl. G02F 1/133

(52) U.S. Cl. CPC G02F 1/13306
USPC 349/36

(57) ABSTRACT

The present invention provides a liquid crystal panel and a liquid crystal display that give a wide viewing angle. The present invention includes a first substrate, a second electrode opposed to the first substrate, and a liquid crystal layer interposed between the first substrate and the second substrate. The first substrate includes a first electrode and a second electrode. The second substrate includes a third electrode. The liquid crystal layer is driven by an electric field generated at least by the first electrode, the second electrode, and the third electrode. The liquid crystal panel includes within a pixel a plurality of regions that are supplied with different voltages to drive the liquid crystal layer.

### TECHNICAL FIELD

The present invention relates to liquid crystal panels and liquid crystal displays. More specifically, the present invention relates to a liquid crystal panel excellent in viewing angle characteristics and a liquid crystal display incorporating the liquid crystal panel.

### BACKGROUND ART

A liquid crystal panel is constructed by interposing a liquid crystal display element between a pair of glass substrates or the like. The liquid crystal panel finds mobile applications, and are used as a variety of types of monitors, televisions, etc., because of features such as a light-weight structure, and low power consumption. The liquid crystal panel now becomes one of the necessary items in daily life and business. The liquid crystal has recently been in widespread use as an electronic book, a photoframe, IA (industrial apparatus), PC (personal computer), or the like. In these applications, liquid crystal panels in a variety of modes different in terms of electrode layout and/or substrate design are being studied to change optical characteristics of the liquid crystal layer.

For example, a disclosed liquid crystal display apparatus having a large number of pixels (see Patent Literature 1) includes a first substrate, a second substrate opposed to the first substrate, a first electrode disposed on the first substrate, and a second electrode that is disposed on the first substrate and isolated from the first electrode, and at least partially is opposed to the first electrode and has a surface continuously flash with the first electrode. A pixel includes at least one of the first electrodes and the second electrode.

### CITATION LIST

### Patent Literature

PTL 1: Japanese Unexamined Patent Application Publication No. 11-316383

### SUMMARY OF INVENTION

### Technical Problem

PTL 1 discloses a technique that is intended to achieve a wide viewing angle and low-voltage driving (for example, see sectional view of eighteenth embodiment (FIG. 96 of PTL 1)) by imparting a variety of changes (a difference in electrode layout and/or a difference in anisotropy of dielectric constant of a liquid crystal material) to a basic FFS (Fringe Field Switching) structure (such as a comb structure/insulating layer/planar electrode (plate electrode)/substrate).

However, PTL 1 fails to disclose a specific drive method of the liquid crystal layer. None of the disclosed structures provide a wide viewing angle.

FIG. 26 is a diagrammatic plan view illustrating a liquid crystal panel as a comparative embodiment 1 having the FFS electrode structure the inventors have studied. FIG. 27 is a diagrammatic sectional view taken along line G-H in FIG. 26. A liquid crystal panel 1100 as the comparative embodiment 1 includes a substrate 1001, a substrate 1002 opposed to the substrate 1001, a liquid crystal layer 1003 interposed between the two substrates, a pair of polarizers 1004 and 1005 arranged outside substrates 1010 and 1040. The substrate 1001 includes an insulating substrate 1010, a planar electrode 1022 is disposed on the insulating substrate 1010, an insulating layer 1018 is disposed on the electrode 1022, a comb-shaped electrode 1020 is disposed on the insulating layer 1018, and an alignment layer 1019 is disposed on the electrode 1020. The substrate 1002 includes an insulating substrate 1040, a planar electrode 1041 is disposed on the insulating substrate 1040, and an alignment layer 1042 is disposed on the electrode 1041. The electrodes 1022 and 1041 are supplied with potentials of the same polarity (0 V is possible), and the electrode 1020 is supplied with a potential of a polarity opposite the polarity of the potential of the electrodes 1022 and 1041. It is noted that the magnitude of the potential of the electrode 1020 may be different from the magnitude of the potential of the electrodes 1022 and 1041. The liquid crystal layer 1003 contains a liquid crystal material having a negative anisotropy of dielectric constant, and liquid crystal molecules thereof are vertically aligned during no-voltage application time.

In the liquid crystal panel 1100, a potential difference between the electrode 1020 and the electrode 1022 is usually determined by a voltage supplied to the electrode 1020. A pull-in voltage generated in a slit portion of the electrode 1020 varies in response to the voltage supplied to the electrode 1020. Because of this, a resulting voltage-transmittance curve (hereinafter referred to as VT curve) is one type only, and liquid crystal panel has thus room for improvement in terms of viewing angle characteristics.

The present invention has been developed in view of the above problem, and it is an object of the present invention to provide a liquid crystal panel and a liquid crystal display that provide a wide viewing angle.

### Solution to Problem

The inventors have studied a variety of liquid crystal panels, and paid attention to a method of driving a liquid crystal layer using at least three electrodes. Since the FFS structure in the related art generates a distribution of one type of electric field within the liquid crystal layer, only one type of VT curve is obtained. The inventors have found that a viewing angle increasing effect provided by the liquid crystal panel including the FFS electrode structure of the related art is limited. At least two types of electrode are arranged on one of the pair of substrates opposed to each other, and at least one type of electrode is arranged on the other substrate. The liquid crystal layer is driven by an electric field generated by these electrodes. Disposed within a pixel are (1) a plurality of regions that are different from each other in voltage to drive the liquid crystal layer, and (2) a plurality of regions that are different in distribution of the electric field. The inventors have found that the regions are made different in VT curve, and have come to a conclusion that the above problem is fully overcome, and have thus developed the present invention.

According to a first aspect of the present invention, there is provided a liquid crystal panel (hereinafter also referred to as a first liquid crystal panel of the present invention) including a first substrate, a second electrode opposed to the first substrate, and a liquid crystal layer interposed between the first substrate and the second substrate. The first substrate includes a first electrode and a second electrode. The second substrate includes a third electrode. The liquid crystal layer is driven by an electric field generated at least by the first electrode, the second electrode, and the third electrode. The liquid crystal panel includes within a pixel a plurality of regions that are supplied with different voltages to drive the liquid crystal layer.

As long as the first liquid crystal panel of the present invention includes these elements as vital elements, including another element may not be interpreted as limiting to the first liquid crystal panel.

According to a second aspect of the present invention, there is provided a liquid crystal panel (hereinafter referred to as a second liquid crystal panel) including a first substrate, a second electrode opposed to the first substrate, and a liquid crystal layer interposed between the first substrate and the second substrate. The first substrate includes a first electrode and a second electrode. The second substrate includes a third electrode. The liquid crystal layer is driven by an electric field generated at least by the first electrode, the second electrode, and the third electrode. The liquid crystal panel includes within a pixel a plurality of regions that are different in distribution of the electric field.

As long as the second liquid crystal panel of the present invention includes these elements as vital elements, including another element may not be interpreted as limiting to the second liquid crystal panel.

The first and second liquid crystal panels of the present invention may be a liquid crystal panel for use in a color liquid crystal display, and the pixel may be an picture element (sub-pixel).

Preferred examples of the first and second liquid crystal panels are described in detail below. The examples described below may be combined as appropriate.

The first electrode may include a plurality of line portions. A slant electric field may be created in the vicinity of an edge of each line portion. The intensity of the electric field in the spacing between the line portions may be relatively weakened. Since a direction of alignment of liquid crystal molecules during voltage application is controlled, disclination is less likely to occur. In a more preferred example of the first electrode, the plurality of line portions extend in parallel side by side with the spacing therebetween maintained.

The second electrode is preferably planer. With this arrangement, an electric field is created effectively between the second electrode and another electrode. If the second electrode is patterned using a photomask, no fault is likely to occur even if an alignment displacement is caused on the photomask. This example is particularly preferable if the first electrode includes the plurality of line portions.

Preferably, the third electrode is at least opposed to the first electrode. With this arrangement, an electric field is effectively created between the third electrode and the first electrode.

The third electrode is preferably planer. With this arrangement, an electric field is created effectively between the third electrode and another electrode. If the third electrode is patterned using a photomask, no fault is likely to occur even if an alignment displacement is caused on the photomask. A patterning operation of the third electrode may be omitted. This example is particularly preferable if the third electrode works as a common electrode.

Although the first electrode and the second electrode may be disposed on the same insulating layer, the first substrate preferably includes an insulating layer between the first electrode and the second electrode. With this arrangement, the use of a pull-in voltage makes effectively a voltage driving the liquid crystal layer and/or a distribution of electric field different between the plurality of regions. Since the first electrode and the second electrode are opposed to each other, a storage capacitor having a sufficient capacitance is ensured.

From the above-described standpoint, the first electrode is preferably laminated on the second electrode if the insulating layer is formed between the first electrode and the second electrode.

Preferably, the first electrode is a pixel electrode, and the third electrode is a common electrode. With this arrangement, the liquid crystal layer is driven in response to an image signal.

The first substrate may further include a fourth electrode, and the liquid crystal layer may be driven by an electric field generated at least by the first electrode, the second electrode, the third electrode, and the fourth electrode.

The fourth electrode is preferably planar. With this arrangement, an electric field is created effectively between the fourth electrode and another electrode. If the fourth electrode is patterned using a photomask, no fault is likely to occur even if an alignment displacement is caused on the photomask. This example is particularly preferable if the first electrode includes the plurality of line portions.

Although the first electrode and the second electrode may be disposed on the same insulating layer, the first substrate preferably includes an insulating layer between the first electrode and the fourth electrode. With this arrangement, the use of a pull-in voltage makes effectively a voltage driving the liquid crystal layer and/or a distribution of electric field different between the plurality of regions. Since the first electrode and the fourth electrode are opposed to each other, a storage capacitor having a sufficient capacitance is ensured.

From the above-described standpoint, the first electrode is preferably laminated on the fourth electrode if the insulating layer is formed between the first electrode and the fourth electrode.

A potential of the second electrode is preferably different in level from a potential of the fourth electrode in a state in which the first electrode is supplied with a voltage. This arrangement makes a voltage difference between the first electrode and the second electrode different from a voltage difference between the first electrode and the fourth electrode. The voltage driving the liquid crystal layer and/or the distribution of electric field is effectively made different depending on the region.

The following examples (1) through (4) with the fourth electrode arranged therewith may be listed as a preferable example to effectively make the voltage driving the liquid crystal layer and/or the distribution of electric field different from region to region.

In the example (1), the second electrode is supplied with the same voltage (signal) as the voltage (signal) supplied to the first electrode, and the fourth electrode is a common electrode.

In the example (2), the second electrode and the fourth electrode are floating electrodes (electrodes in a floating state).

In the example (3), the second electrode is supplied with the same voltage (signal) as the voltage (signal) supplied to the first electrode, and the fourth electrode is a floating electrode.

In the example (4), the first electrode includes a plurality of first line portions arranged side by side with a spacing maintained therebetween, and a plurality of second line portions arranged side by side with a spacing maintained therebetween, the first line portions are arranged within a first region of the plurality of regions, the second line portions are arranged within a second region of the plurality of regions, and the spacing between the first line portions is wider than the spacing between the second line portions.

According to the examples (1) and (3), an area having the second electrode is brightened, and transmittance there is increased.

In the example (1), the second electrode is preferably electrically connected to the first electrode. In this way, the same voltage (signal) as the voltage (signal) supplied to the first electrode is easily supplied to the second electrode.

Preferably in the second example (2), a first capacitor is formed between the first electrode and the second electrode, a second capacitor is formed between the first electrode and the fourth electrode, and the first capacitor is different in capacitance from the second capacitor. This arrangement effectively makes a pull-in voltage to the second electrode different from a pull-in voltage to the fourth electrode.

Preferably in the example (3), the second electrode is electrically connected to the first electrode, and a capacitor is formed between the first electrode and the fourth electrode. This arrangement allows the same voltage (signal) as the voltage (signal) supplied to the first electrode to be easily supplied to the second electrode. This arrangement also effectively makes the pull-in voltage to the second electrode different from the pull-in voltage to the fourth electrode.

Preferably in the examples (1) and (3), the potential of the second electrode preferably becomes equal in level to the potential of the first electrode when the first and second liquid crystal panels are in a white display state. This arrangement allows white luminance to increase.

In the description, the example that allows the potential of one electrode to be equal in level to the potential of another electrode does not necessarily mean that the two potentials are strictly at the same level. The equality of the two potentials is as high as the degree of equality that can be achieved when the two electrodes are electrically connected to each other.

In an example, the potential of the second electrode may be different in level from the potential of the first electrode in a state in which the first electrode is supplied with a voltage (hereinafter referred to as an example (5)). This arrangement, without the need for the fourth electrode on the first substrate, effectively makes the voltage driving the liquid crystal layer and/or the distribution of electric field different depending the region.

In the example (5), the second electrode is preferably a common electrode. This arrangement effectively creates a pull-in voltage to the second electrode.

Preferably in the example (5), the first electrode includes a plurality of first line portions arranged side by side with a spacing maintained therebetween, and a planar portion. The first line portions are arranged within a first region of the plurality of regions. The planar portion is arranged in a second region of the plurality of regions. With this arrangement, the voltage driving the liquid crystal layer and/or the distribution of electric field is effectively made different from an area having the plurality of line portions to an area having the planar portion. Since the planar portion is brightened in the planar portion, transmittance is increased there.

The first and second liquid crystal panels of the present invention may be a horizontal alignment liquid crystal panel. From the standpoint of high contrast, a vertical alignment liquid crystal panel is preferable. An ordinary vertical alignment liquid crystal panel has room for improvement in terms of viewing angle characteristics. In contrast, the first and second liquid crystal panels of the present invention have excellent viewing angle characteristics. The first and second liquid crystal panels of the present invention, if being a vertical alignment liquid crystal panel, provide a wide viewing angle and high contrast.

The liquid crystal layer may contain liquid crystal molecules having a positive anisotropy of dielectric constant. Preferably, however, the liquid crystal layer contains liquid crystal molecules having a negative anisotropy of dielectric constant. Since this arrangement more effectively controls the alignment of the liquid crystal molecules, transmittance is increased.

The first and second liquid crystal panels of the present invention may further include a circularly polarizing plate or a linear polarizing plate. The use of the circularly polarizing plate increases transmittance. The use of the linear polarizing plate improves the viewing angle characteristics. An ordinary liquid crystal panel including a circularly polarizing plate has room for improvement in terms of the viewing angle characteristics. In contrast, the first and second liquid crystal panels of the present invention provide excellent viewing angle characteristics. The first and second liquid crystal panels of the present invention, further including the circularly polarizing plate, provide a wide viewing angle and high contrast.

If the first electrode includes the plurality of line portions (the line portions may include the first line portion and the second line portion), an optical axis of the circularly polarizing plate preferably is orthogonal to or is in parallel with the line portion. If a ratio of a distance D between center lines of the line portions to a cell gap d, i.e., the ratio D/d is very small (for example, D/d<1), this arrangement effectively improves γ shift in comparison with the case in which the optical axis of the circularly polarizing plate is placed in a slant direction with respect to the line portion. The term orthogonal does not necessarily mean that an angle made by the optical axis and the line portion is strictly 90°, and it is sufficient if the optical axis is substantially orthogonal. Specifically, the angle made by the optical axis and the line portion is preferably 86° or more (more preferably 88° or more). The term parallel does not necessarily mean that the angle made by the optical axis and the line portion is strictly 0°. It is sufficient if the optical axis is substantially in parallel with the line portion. Specifically, the angle made by the optical axis and the line portion is preferably 4° or less (more preferably 2° or less).

The circularly polarizing plate is not particularly limited to any type and any structure. For example, a standard circularly polarizing plate typically used in the field of displays may be employed. The circularly polarizing plate is a laminate including a λ/4 plate and a linear polarizing plate (linear polarizer). A structure having an optical pitch of a helical structure (such as cholesteric liquid crystal) is preferably used for the circularly polarizing plate.

The linear polarizing plate is not limited to any particular type and structure. For example, a standard linear polarizing plate typically used in the field of displays may be used.

The first and second liquid crystal panels of the present invention may be any of transmissive type, reflective type, and semi-transmissive type. If the liquid crystal panels are transmissive type or semi-transmissive type, each of the first and second liquid crystal panels of the present invention preferably further includes a pair of circularly polarizing plates or a pair of linear polarizing plates.

The liquid crystal layer preferably includes a chiral agent. The stability of alignment of the liquid crystal molecules is thus increased.

Preferably, the first substrate includes a first alignment layer, and a first alignment assisting layer disposed on the first alignment layer, and the second substrate includes a second alignment layer, and a second alignment assisting layer disposed on the second alignment layer. With this arrangement, the stability of alignment of the liquid crystal molecules is increased. A change in luminance responsive to a pressure by an object such as a touchpen is decreased. This example is particularly preferable if the first and second liquid crystal panels of the present invention are vertical alignment liquid crystal panels.

The second substrate may include an alignment anchoring structure. This arrangement increases the stability of alignment of the liquid crystal molecules.

Preferable examples of the alignment anchoring structures may include an aperture disposed in the third electrode and a projection disposed on the third electrode.

According to a third aspect of the present invention, there is provided a liquid crystal display including the first liquid crystal panel of the present invention.

According to a fourth aspect of the present invention, there is provided a liquid crystal display including the second liquid crystal panel of the present invention.

### Advantageous Effects of Invention

The present invention provides a liquid crystal panel and a liquid crystal display that provide a wide viewing angle.

### BRIEF DESCRIPTION OF DRAWINGS

FIG. 1 is a plan view diagrammatically illustrating a liquid crystal display of a first embodiment.

FIG. 2 is a sectional view diagrammatically illustrating a section taken along lines A-B and C-D in FIG. 1.

FIG. 3 is a perspective view diagrammatically illustrating a model of a pixel used in a simulation test.

FIG. 4 is a sectional view diagrammatically illustrating a section taken along line E-F in FIG. 3.

FIG. 5 illustrates transmittance and liquid crystal alignment state of a sample 1 determined in the simulation test.

FIG. 6 illustrates transmittance and liquid crystal alignment state of a sample 2 determined in the simulation test.

FIG. 7 illustrates transmittance and liquid crystal alignment state of a sample 3 determined in the simulation test.

FIG. 8 illustrates transmittance and liquid crystal alignment state of a sample 4 determined in the simulation test.

FIG. 9 illustrates VT curves of the samples 1 through 4.

FIG. 10 illustrates a γ shift of the sample 1 determined in the simulation test.

FIG. 11 illustrates a γ shift of the sample 2 determined in the simulation test.

FIG. 12 illustrates a γ shift of the sample 3 determined in the simulation test.

FIG. 13 illustrates a γ shift of the sample 4 determined in the simulation test.

FIG. 14 illustrates a γ shift of a sample 5 determined in the simulation test.

FIG. 15 illustrates a γ shift of a sample 6 determined in the simulation test.

FIG. 16 illustrates a γ shift of a sample 7 determined in the simulation test.

FIG. 17 is a plan view diagrammatically illustrating the liquid crystal display of a second embodiment.

FIG. 18 is a plan view diagrammatically illustrating the liquid crystal display of a third embodiment.

FIG. 19 is a plan view diagrammatically illustrating the liquid crystal display of a fourth embodiment.

FIG. 20 is a plan view diagrammatically illustrating the liquid crystal display of a fifth embodiment.

FIG. 21 is a plan view diagrammatically illustrating a first modification of the liquid crystal display of the fifth embodiment.

FIG. 22 is a sectional view diagrammatically illustrating a second modification of the liquid crystal display of the fifth embodiment.

FIG. 23 is a sectional view diagrammatically illustrating a third modification of the liquid crystal display of the fifth embodiment.

FIG. 24 is a sectional view diagrammatically illustrating the liquid crystal display of a sixth embodiment.

FIG. 25 is a sectional view diagrammatically illustrating the liquid crystal display of a seventh embodiment.

FIG. 26 is a plan view diagrammatically illustrating the liquid crystal panel as a first comparative embodiment having an FFS electrode structure the inventors has studied.

FIG. 27 is a sectional view diagrammatically illustrating a section taken along line G-H in FIG. 26.

### DESCRIPTION OF EMBODIMENTS

The present invention is described in detail below by exemplifying embodiments thereof with reference to the drawings. The present invention is not limited these embodiments only.

In each of the embodiments, the 3 o'clock direction, the 12 o'clock direction, the 9 o'clock direction, and the 6 o'clock direction on a front view of a liquid crystal panel are respectively referred to as an azimuth angle of 0°, an azimuth angle of 90°, an azimuth angle of 180°, and an azimuth angle of 270°, a direction aligned with a line connecting the 3 o'clock and the 9 o'clock is referred to as a left-right direction, and a direction aligned with a line connecting the 12 o'clock and the 6 o'clock is referred to as an up-down direction. The term front view means that the front of the liquid crystal panel is viewed in a direction normal to the screen of the liquid crystal panel. A normal direction means the direction normal to the screen of the liquid crystal panel.

Drawings discussed below illustrate only a single picture element (sub pixel), but a display area of a liquid crystal display of each embodiment (area displaying an image) includes a plurality of pixels in a matrix formation. Each pixel includes a plurality of picture element (typically three picture elements).

### First Embodiment

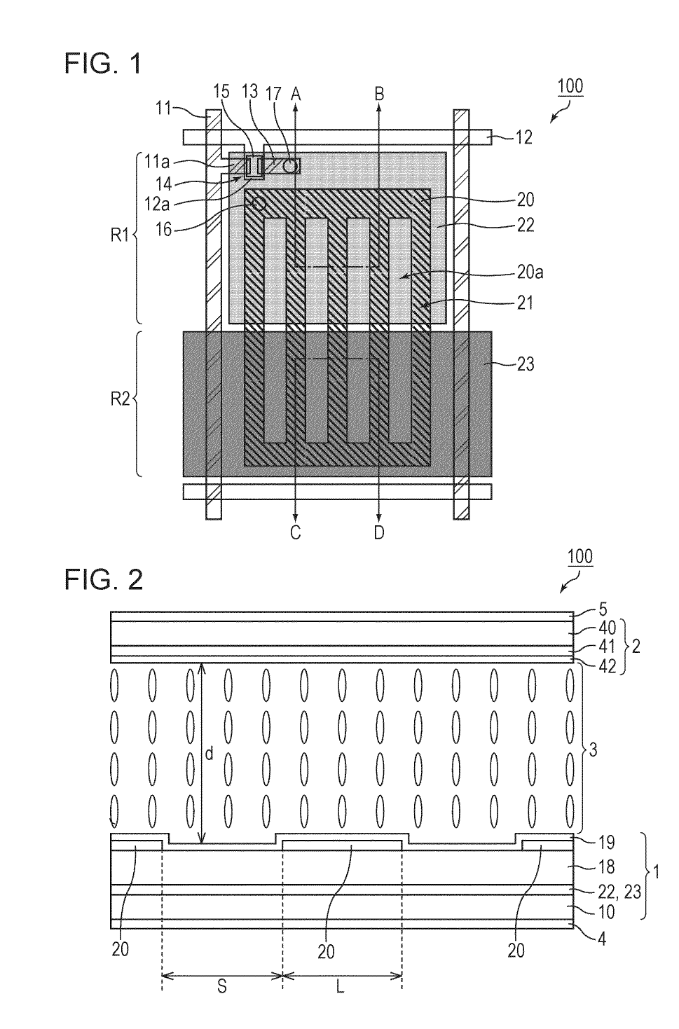

FIG. 1 diagrammatically illustrates a liquid crystal display of a first embodiment. FIG. 2 is a sectional view diagrammatically illustrating a section taken along lines A-B and C-D in FIG. 1. Since the sectional structure along the line A-B in FIG. 1 and the sectional structure along the line C-D are different from each other only in terms of the type of a lower-layer electrode, FIG. 2 represents the two sectional structures by one drawing.

As illustrated in FIG. 1 and FIG. 2, the liquid crystal display of the present embodiment includes a liquid crystal panel 100, a backlight unit (not illustrated) arranged behind the liquid crystal panel 100, and a control unit (not illustrated) that drives and controls the liquid crystal panel 100 and the backlight unit.

The liquid crystal panel 100 includes an active matrix substrate (TFT array substrate) 1 (hereinafter also simply referred to as a substrate 1) corresponding to the first substrate, a counter substrate 2 (hereinafter also simply referred to as a substrate 2) opposed to the substrate 1, a liquid crystal layer 3 interposed between these substrates, and a pair of circularly polarizing plates 4 and 5 on the sides of the substrates 1 and 2 opposed to the sides facing the liquid crystal layer 3. The substrate 1 is arranged on the rear side of the liquid crystal display, and the substrate 2 is arranged on the side of the liquid crystal display facing a viewer.

The substrates 1 and 2 are glued to each other by a sealing member (not illustrated) that surrounds a display area. The substrates 1 and 2 are opposed to each other with a spacer (not illustrated) such as plastic beads. A gap between the substrates 1 and 2 is filled with a liquid crystal material, thereby forming the liquid crystal layer 3 serving as an optical modulation layer. The liquid crystal layer 3 contains nematic liquid crystal molecules having a negative anisotropy of dielectric constant.

The active matrix substrate 1 includes a colorless and transparent insulating substrate 10 manufactured of a material, such as glass, plastic, or the like. Arranged on the main surface of the insulating substrate 10 to the side of the liquid crystal layer 3 are a plurality of gate bus lines 12 mutually in parallel to each other (hereinafter also simply referred to as bus lines 12), a plurality of source bus lines 11 (hereinafter also simply referred to as bus lines 11) intersecting the gate bus lines 12, a thin film transistor (TFT) 14 serving as a switching element and arranged in each picture element, an upper-layer electrode (pixel electrode) 20 (hereinafter also simply referred to as an electrode 20) corresponding to the first electrode and arranged in each picture element, a lower-layer electrode 22 arranged in each picture element (hereinafter also simply referred to as electrode 22), a plurality of lower-layer electrodes (common electrodes) 23 (hereinafter also simply referred to as electrodes 23), and a vertical alignment film 19. One of the lower-layer electrodes 22 and 23 corresponds to the second electrode, and the other of the lower-layer electrodes 22 and 23 corresponds to the fourth electrode. An area delineated by the bus lines 11 and 12 generally forms one picture element region. Each lower-layer electrode 23 is commonly arranged to picture elements adjacent to each other in a direction in which the gate bus line 12 extends across a plurality of picture elements (hereinafter also referred to as the picture elements in the left-right direction).

The TFT 14 includes a gate electrode 12a that functions as a gate and is connected to the gate bus line 12, a source electrode 11a that functions as a source and is connected to the source bus line 11, and a drain electrode 13 that functions as a drain. The TFT 14 is arranged in the vicinity of each intersection of the bus lines 11 and 12, and includes a semiconductor layer 15 disposed as an island on the gate electrode 12a.

The source bus line 11 is connected to a source driver (not illustrated) outside the display area. The gate bus line 12 is connected to a gate driver (not illustrated) outside the display area, and is connected to the gate electrode 12a of the TFT 14 within the display area. The gate driver supplies a scan signal in a pulse shape to the gate bus line 12 at a predetermined timing. The scan signal is thus supplied to the TFTs 14 in a line-sequential system.

The sectional structure of the substrate 1 is then described. Laminated on the insulating substrate 10 are a first wiring layer, a gate insulating layer (not illustrated) covering the first wiring layer, the semiconductor layer 15, a second wiring layer, a first insulating layer (not illustrated) covering the second wiring layer, a lower-layer electrode layer, a second insulating layer 18 covering the lower-layer electrode layer, the upper-layer electrode 20, and the vertical alignment film 19 successively in that order. The gate bus line 12 and the gate electrode 12a are disposed in the first wiring layer, and the source bus line 11, the source electrode 11a, and the drain electrode 13 are disposed in the second wiring layer. The lower-layer electrodes 22 and 23 are disposed in the lower-layer electrode layer. In this way, the lower-layer electrodes 22 and 23 and the upper-layer electrode 20 are arranged with the second insulating layer 18 interposed therebetween.

The substrate 2 includes a colorless and transparent insulating substrate 40 manufactured of a material, such as glass or plastic. Laminated on the main surface of the insulating substrate 40 to the side of the liquid crystal layer 3 are a color filter layer (not illustrated), a counter electrode 41 (hereinafter also simply referred to as an electrode 41) corresponding to the third electrode, and a vertical alignment film 42 in that order. The counter electrode 41 is planar, and disposed so that the counter electrode 41 entirely covers the display area in a seamless fashion. Also, the counter electrode 41 is opposed to the upper-layer electrode 20.

Each picture element includes two regions R1 and R2 into which a picture element region is generally halved. The lower-layer electrodes 22 and 23 are arranged respectively for the regions R1 and R2. Each of the lower-layer electrodes 22 and 23 is planar. The lower-layer electrode 23 may also be considered to be band-shaped, and covers the regions R2 of the picture elements in the left-right direction. The lower-layer electrodes 23 are interconnected to each other outside the display area. The upper-layer electrode 20 is arranged on the regions R1 and R2, namely, the picture element so that the upper-layer electrode 20 are opposed to the lower-layer electrodes 22 and 23.

If electrodes 20, 22, 23, and 41 are supplied with voltages so that voltage differences occur, an electric field is created between these electrodes. The liquid crystal layer 3 is driven (controlled) by the created electric field. By adjusting the voltages to these electrodes appropriately, the distribution of the electric field is made different from the region R1 to the region R2. In other words, the voltage supplied to the liquid crystal layer 3 is made different from the region R1 to the region R2. Therefore, the VT curve in the region R1 is different from the VT curve in the region R2. The viewing angle characteristics of (γ shift, for example) of the liquid-crystal panel 100 are thus improved.

By supplying the voltages to the electrodes 20, 22, 23, and 41 appropriately in the liquid-crystal panel 100, the liquid crystal molecules in the liquid crystal layer 3 are tilted in a direction horizontal with the substrates 1 and 2, namely, in a direction parallel with the surfaces of the substrates 1 and 2. The tilt angle of the liquid crystal molecules is controlled by adjusting the voltages to the electrodes 20, 22, 23, and 41 appropriately. Light transmittance from the backlight unit is adjusted.

The principle of the viewing angle characteristics improvement of the liquid-crystal panel 100 is further described below.

The upper-layer electrode 20 includes a plurality of slits (elongated apertures) 20a mutually in parallel with each other. As a result, the upper-layer electrode 20 includes a plurality of line portions 21 extending in parallel with a spacing therebetween. The slits 20a and the line portions 21 extend in the up-down direction substantially in parallel with the source bus line 11, and are arranged in the regions R1 and R2. The slits 20a and the line portions 21 are disposed so that the slits 20a and the line portions 21 are opposed to the lower-layer electrodes 22 and 23.

The upper-layer electrode 20 is electrically connected to the lower-layer electrode 22 via a contact hole 16 arranged in the second insulating layer 18. The lower-layer electrode 22 is electrically connected to the drain electrode 13 of the TFT 14 via a contact hole 17 arranged in the first insulating layer.

The TFT 14 turns on in response to an input of the scan signal and remains turned on for a constant period of time. While the TFT 14 remains turned on, the lower-layer electrode 22 and the upper-layer electrode 20 are supplied with an image signal at a predetermined timing via the source bus line 11. In other words, the electrodes 20 and 22 are supplied with a voltage responsive to the image signal, and then function as a pixel electrode.

On the other hand, the lower-layer electrode 23 is an electrode to supply a common voltage to all picture elements (common electrode). The lower-layer electrode 23 is supplied with a predetermined DC voltage (0 V for example). The counter electrode 41 is also a common electrode, and is supplied with a predetermined voltage (an AC voltage or a DC voltage, 0 V, for example).

The lower-layer electrode 22 is supplied with a voltage responsive to the image signal while the lower-layer electrode 23 is supplied with the predetermined DC voltage. For this reason, a potential difference occurs between the lower-layer electrode 22 and the lower-layer electrode 23 after the supplying of the image signal, and a difference occurs between a voltage pulled in to the lower-layer electrode 22 (pull-in voltage ΔVd, 22) and a voltage pulled in to the lower-layer electrode 23 (pull-in voltage ΔVd, 23). Typically, ΔVd, 22>ΔVd, 23. As a result, the following difference occurs between the region R1 and the region R2. The electric field (the distribution of the electric field) created in the liquid crystal layer 3 becomes different. The voltages driving the liquid crystal layer 3 (the voltage supplied to the liquid crystal layer 3) become different. The VT curves become different. As a result, the viewing angle characteristics (such as the γ shift) are improved.

The image signal, after being written on the liquid crystal layer 3, is held on the electrodes 20, 22, 23, and 41 for a constant period of time, and capacitors (liquid crystal capacitors) are created between these electrodes for a constant period of time. A storage capacitor is formed in parallel with the liquid crystal capacitor to prevent the stored image signal from being leaked. The storage capacitor is formed in each picture element in the second insulating layer 18 between the upper-layer electrode 20 and the lower-layer electrode 23.

The upper-layer electrode 20 includes the plurality of line portions 21. For this reason, a slant electric field is created in the vicinity of the edge of each line portion 21. The intensity of the electric field in the spacing, namely, the slit 20a between the line portions 21 is relatively weak. Since the direction of the alignment of the liquid crystal molecules is controlled during voltage application, disclination is less likely to occur. More in detail, during voltage application, the liquid crystal molecules turn over on the line portions 21 so that the long axes (directors) thereof are aligned with the longitudinal direction of the line portions 21.

The liquid-crystal panel 100 and elements thereof are further described.

The widths of the line and space of the upper-layer electrode 20, in other words, the line portion 21 and the slit 20a are appropriately set. Typically, the width L of the line portion 21 is from 1 to 8 μm (preferably from 2 to 4 μm), and the width S of the slit 20a is from 1 to 8 μm (preferably from 2 to 4 μm).

In the description, the width of the line portion is intended to mean a length of the line portion in a direction perpendicular to the longitudinal direction of the line portion, and the width of the slit is intended to mean a length of the slit in a direction perpendicular to the longitudinal direction of the slit.

The backlight unit and the controller may be any of those available in the related art.

The circularly polarizing plates 4 and 5 are optical elements that allows one of a right-handed polarized light beam and a left-handed polarized light beam to transmit therethrough, and absorbs or blocks the other of the right-handed polarized light beam and the left-handed polarized light beam.

The circularly polarizing plates 4 and 5 are crossed Nichol arranged to each other. The circularly polarizing plate 4 includes a first λ/4 plate (not illustrated) and a first linear polarizing plate (not illustrated) laminated in that order on the substrate 1. An angle made by an optical axis (slow axis) of the first λ/4 plate and an absorption axis of the first linear polarizing plate is set to be about 45°. The circularly polarizing plate 5 includes a second λ/4 plate (not illustrated) and a second linear polarizing plate (not illustrated) laminated in that order on the substrate 2. An angle made by an optical axis (slow axis) of the second λ/4 plate and an absorption axis of the second linear polarizing plate is set to be about 45°. The optical axes (slow axes) of the first and second λ/4 plates are approximately perpendicular to each other. The absorption axes of the first and second linear polarizing plates are approximately perpendicular to each other.

As long as the azimuth angles of the absorption axes of the first and second linear polarizing plates are approximately perpendicular to each other, no particular limitation is imposed on the azimuth angles. Any azimuth angles are acceptable. If the ratio of the distance D between the center lines of the line portion 21 to the cell gap d, D/d, is very small (for example, D/d<1), the absorption axes of the first and second linear polarizing plates preferably intersect the line portion 21 at the right angle or are in parallel with the line portion 21. In this way, if D/d is very small, the γ shift is more effectively improved than when the absorption axes of the first and second linear polarizing plates are placed at a slant angle with respect to the line portion 21.

In order to further improve the viewing angle characteristics, an optical film, such as a retardation plate, may be interposed, at least, between the substrate 1 and the circularly polarizing plate 4 or between the substrate 2 and the circularly polarizing plate 5.

The liquid crystal layer 3 contains nematic liquid crystal molecules having a negative anisotropy of dielectric constant as described above. The liquid crystal molecules are homeotropically aligned in response to anchoring forces of the vertical alignment films 19 and 42 when no voltage is supplied (when no electric fields are created by the four electrodes 20, 22, 23, and 41). The pretilt angle of the liquid crystal layer 3 falls within a range of 86° or higher (preferably 88° or higher) to 90° or lower. If the pretilt of the liquid crystal layer 3 is lower than 86°, contrast may be decreased.

Since the liquid-crystal panel 100 includes a pair of circularly polarizing plates 4 that are crossed Nichol arranged, and the vertical alignment liquid crystal layer 3, the liquid-crystal panel 100 operates in a normally black mode.

The vertical alignment films 19 and 42 are disposed in a seamless fashion to cover at least the entire display area. The vertical alignment films 19 and 42 cause nearby liquid crystal molecules to be substantially vertically aligned with respect to the surfaces thereof. The material of the vertical alignment films 19 and 42 is not limited to any particular one. For example, the materials of the vertical alignment films 19 and 42 may be an alignment film for use in the FFS mode in the related art, an alignment film for use in the vertical alignment (VA) mode, a light alignment film for use in a vertical alignment twisted nematic (VATN) mode, or the like. The vertical alignment films 19 and 42 may be an organic alignment film that is manufactured of an organic material containing polyimide, or an inorganic alignment film that is manufactured of an inorganic material containing silicon oxide.

Methods of forming the vertical alignment films 19 and 42 from a light alignment material include a method of imparting to the films a pretilt angle of about 90° by vertically irradiating the light alignment film with ultraviolet light. The vertical alignment films 19 and 42 may be those that have undergone an alignment process including a rubbing operation and an ultraviolet light irradiation operation. However, the vertical alignment films 19 and 42 which have not undergone the alignment process are preferable, and the vertical alignment films 19 and 42 to which a vertical alignment property is imparted by film forming only are more preferable. In this way, the alignment process is omitted and manufacturing process is simplified.

The cell gap d falls within a range of 2.8 through 4.5 μm (preferably 3.0 through 3.4 μm). The product (panel retardation) of the cell gap d and birefringence Δn of the liquid crystal material (a value responsive to light having a wavelength λ) preferably approximately satisfies λ/2. Specifically, the product preferably satisfies 280 nm≦dΔn≦450 nm, and more preferably, the product satisfies 280 nm≦dΔn≦340 nm.

The liquid crystal layer 3 further contains a chiral agent. The stability of the alignment of the liquid crystal molecules is thus increased. The chiral pitch length of the chiral agent is preferably 10 μm or longer, and display quality is increased.

The second insulating layer 18 is manufactured of a transparent insulating material. Specifically, the second insulating layer 18 is manufactured of an inorganic insulating film, such as of silicon oxide or silicon nitride, or an organic insulating film, such as of acrylic resin. The thickness of the second insulating layer 18 falls within a range of 0.1 through 3.2 μm. The second insulating layer 218 is preferably an insulating film of SiN having a thickness of 0.1 through 0.3 μm, or an insulating film of acrylic resin having a thickness of 1 to 3.2 μm. The second insulating layer 18 may be a laminate of a plurality of layers and in such a case, the plurality of layers may be of different materials. The lower-layer electrodes 22 and 23 and the upper-layer electrode 20 are manufactured of a transparent conductive film, such as of indium tin oxide (ITO) or indium zinc oxide (IZO).

Materials of elements arranged on the substrate 1 other than those described above (such as the bus lines 11 and 12, the semiconductor layer 15) may be related art materials.

The counter electrode 41 is manufactured of a transparent conductive film, such as of indium tin dioxide (ITO) or indium zinc oxide (IZO).

The color filter layer includes a plurality of color layers (color filters) arranged for each picture element. The color layer is used to present a color display, and manufactured of a transparent organic insulating film, such as acrylic resin containing a pigment. The color layer is mainly disposed in the picture element region. With the color layer, color displaying can be presented. Each pixel includes three picture elements that respectively emit R (red), G (green) and B (black) color light rays. The type and the number of the picture elements forming each pixel are not limited to particular type and value, respectively. Any type and number of picture elements are acceptable. For example, each pixel may include three color picture elements of cyan, magenta, and yellow. Each pixel may includes picture elements of four or more colors (such as R, G, B, and Y (yellow)).

The color filter layer may further include a black matrix (BM) layer that blocks light between picture elements. The BM layer is manufactured of an opaque metallic film (such as chromium film) and/or an opaque organic film (such as of acrylic resin containing carbon), and is disposed in a border region between adjacent picture elements.

Described below a simulation test the inventors of this invention had done in order to verify the operation and advantages of the present embodiment. PRIME-3D manufactured by Syntek was used in the simulation test.

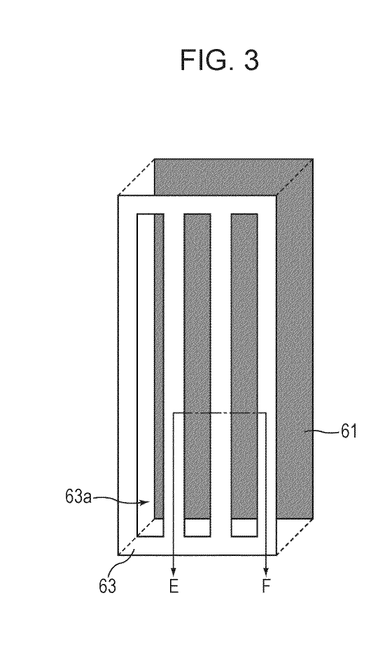

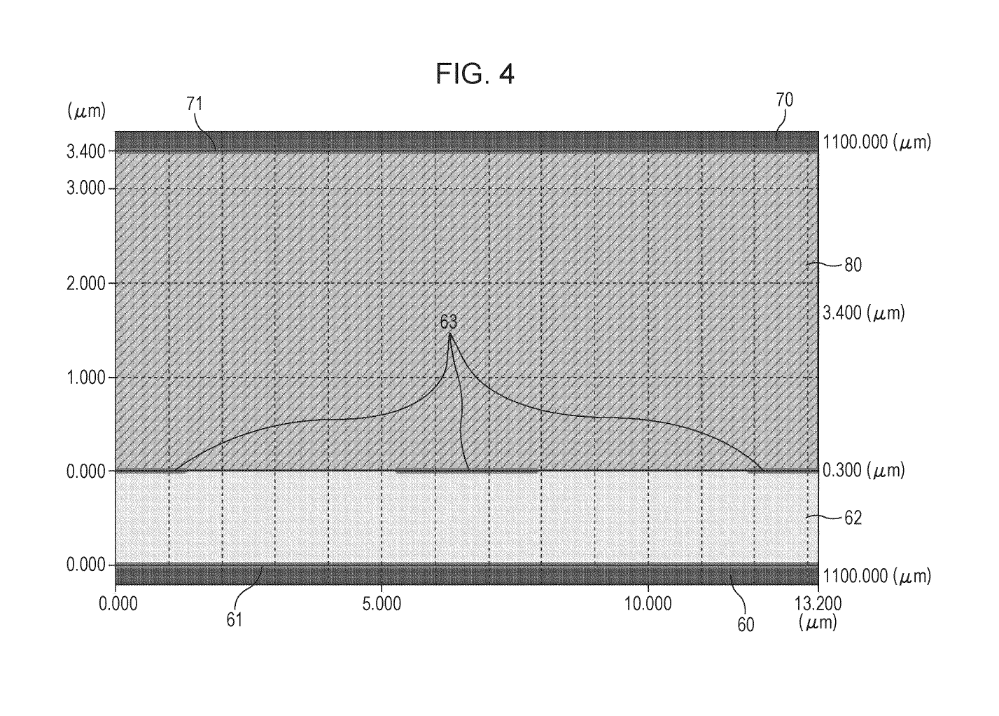

FIG. 3 is a perspective view illustrating the model of a pixel used in the simulation test. FIG. 4 is a sectional view taken along line E-F in FIG. 3.

The pixel in the simulation test included a pair substrates 60 and 70, a liquid crystal layer 80 interposed between the substrates 60 and 70, a pair of circularly polarizing plates (not illustrated) arranged outside the pair of substrates, a lower-layer electrode 61 disposed on the substrate 60, an insulating layer 62 disposed on the lower-layer electrode 61, an upper-layer electrode 63 disposed on the insulating layer 62, and a planar counter electrode 71 disposed on the substrate 70. The liquid crystal layer was a vertical alignment liquid crystal layer, and contains liquid crystal molecules having a negative anisotropy of dielectric constant. The pair of circularly polarizing plates are crossed Nichol arranged to each other.

The upper-layer electrode 63 included three mutually parallel slits 63a. The longitudinal direction of the slits 63a is set to look towards an azimuth angle of 90°. The upper-layer electrode 63 is supplied with a voltage of 0 to 5 V corresponding to a drain voltage (an image signal, or a liquid crystal drive voltage).

The counter electrode 71 is set to 0 V.

The lower-layer electrode 61 is supplied with a voltage that results from reducing a voltage supplied to the insulating layer 62 by a constant percentage or a voltage equal in magnitude to the voltage supplied to the upper-layer electrode 63.

Four samples different in voltage supplied to the lower-layer electrode 61 are calculated. The lower-layer electrode 61 is supplied with 0 V in a sample 1, supplied with 0 to 2.5 V in a sample 2, supplied with 0 to 3.5 V in a sample 3, and supplied with 0 to 5 V in a sample 4. In other words, if the voltage supplied to the lower-layer electrode 61 is expressed by percentage (%) with respect to the voltage supplied to the upper-layer electrode 63, the lower-layer electrode 61 is supplied with a 0% voltage in the sample 1, supplied with a 50% voltage in the sample 2, supplied with a 70% voltage in the sample 3, and supplied with a 100% voltage in the sample 4.

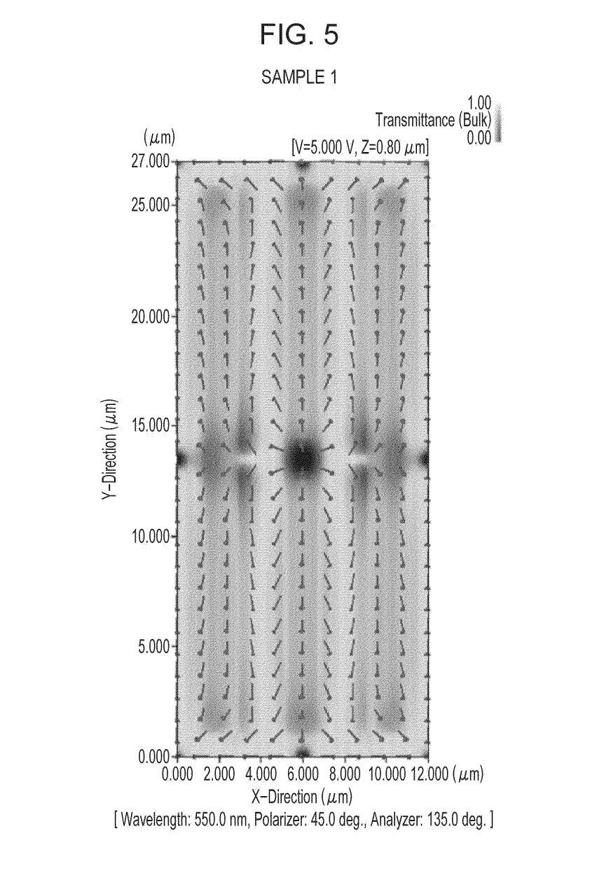

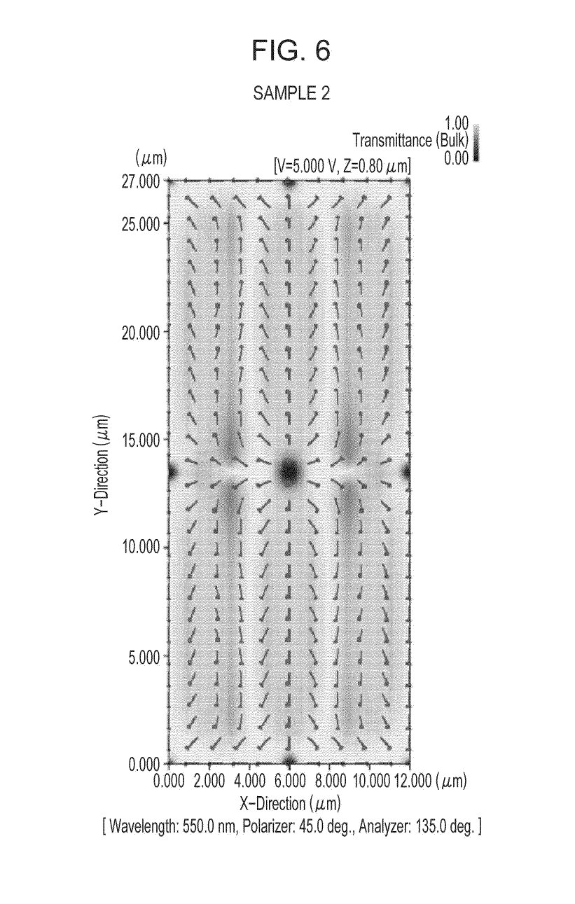

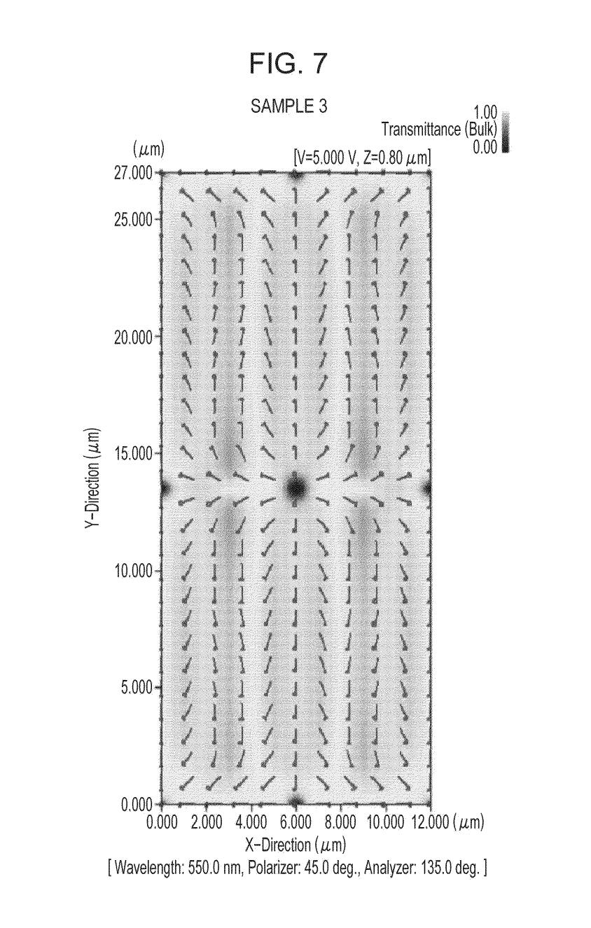

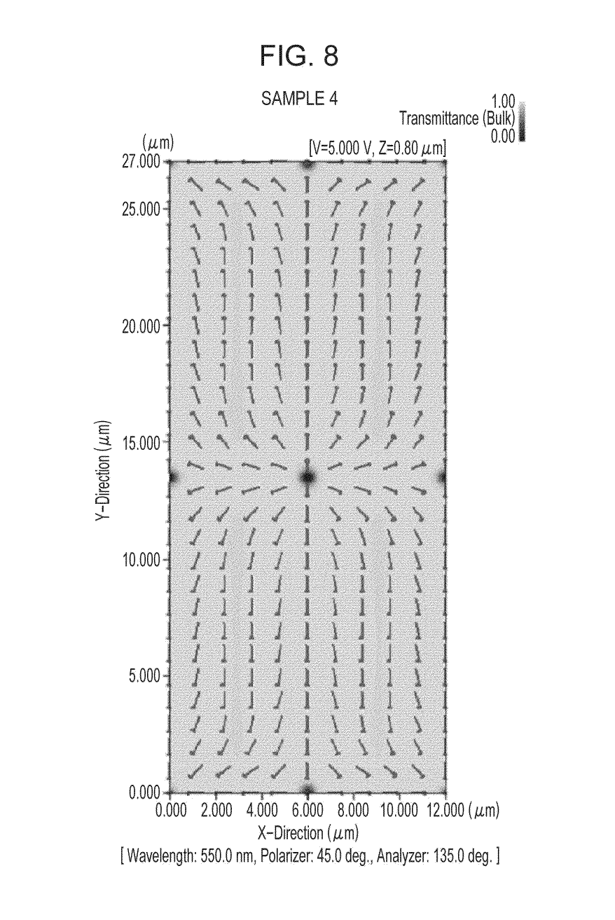

FIGS. 5 through 8 illustrate transmittances and liquid crystal alignment states of the samples 1 through 4 determined in the simulation test. In each of FIGS. 5 through 8, the upper-layer electrode 63 is supplied with 5 V. Small bars in FIGS. 5 through 8 represent directors of the liquid crystal molecules. Density of color represents the magnitude of transmittance. The denser the color is, the smaller the transmittance is.

As illustrated in FIGS. 5 through 8, the smaller the difference between the voltage supplied to the lower-layer electrode 61 and the voltage supplied to the upper-layer electrode 63 is, the brighter the regions of the slits 63a become.

This is because as the voltage supplied to the lower-layer electrode 61 becomes closer in magnitude to the voltage supplied to the upper-layer electrode 63, a loss in the transmittance caused by the pull-in voltage created in the regions of the slits 63a decreases, and the transmittance in the regions of the slits 63a increases.

The results of FIGS. 5 through 8 imply that the samples 1 through 4 result in mutually different VT curves.

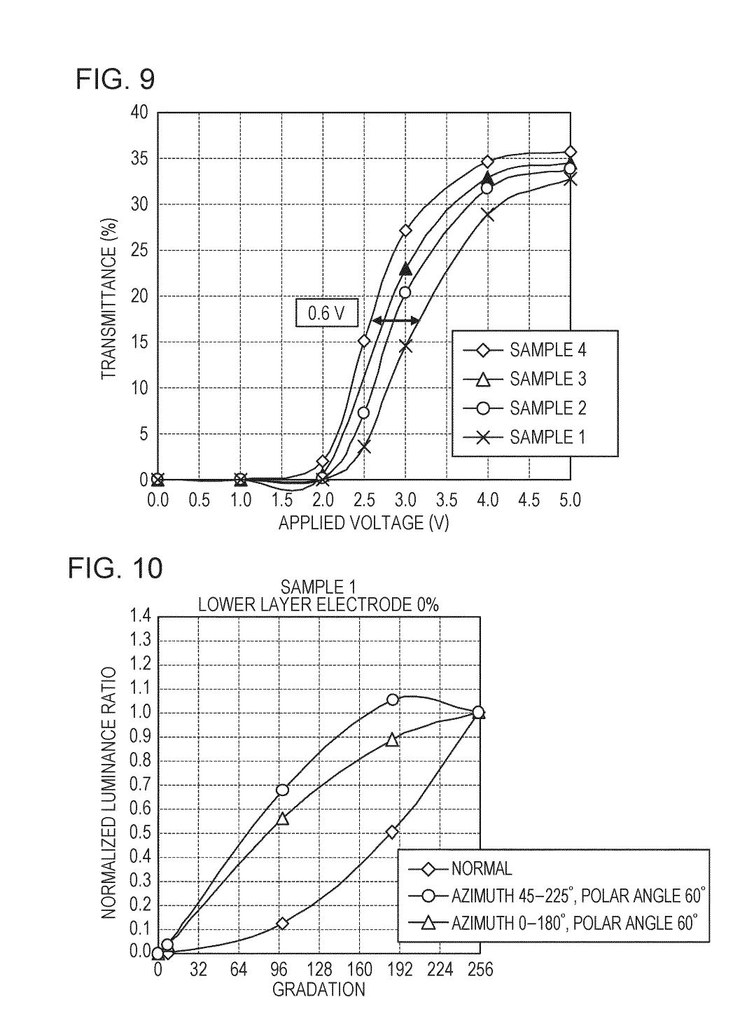

FIG. 9 illustrates the VT curves of the samples 1 through 4.

As illustrated in FIG. 9, the VT curve is shifted by varying the voltage supplied to the lower-layer electrode 61. A maximum voltage difference at an intermediate gradation was obtained between the sample 1 and the sample 4, and was about 0.6 V.

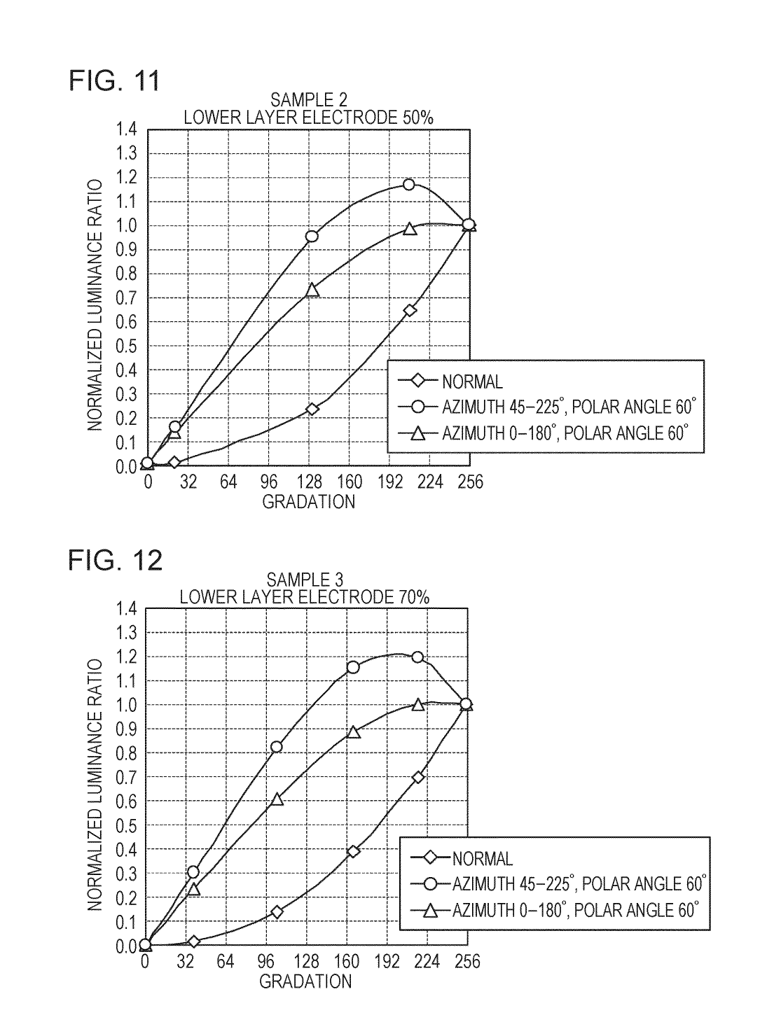

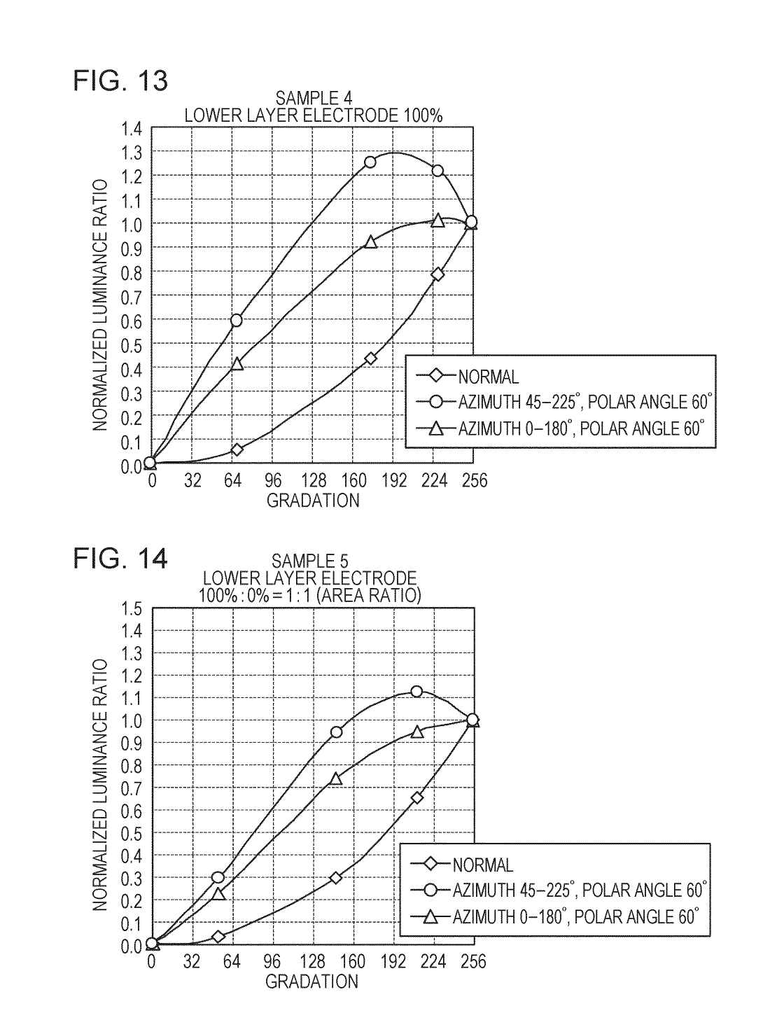

FIGS. 10 through 13 illustrate γ shifts of the samples 1 through 4 determined in the simulation test. The γ shift indicates how much the γ curve changes in a slant direction with respect to the γ curve in the normal direction.

In FIGS. 10 through 13, the abscissa represents gradation and the ordinate represents a normalized luminance ratio. The normalized luminance ratio indicates a ratio of the luminance of each gradation to the luminance of a maximum gradation (of 255 gradations). In FIGS. 10 through 13, each plot is corrected with γ=2.2. FIGS. 10 through 13 illustrate results in the normal direction, in the direction of a polar angle 60° and an azimuth angle of 45° or 225°, and in the direction of a polar angle 60° and an azimuth angle of 0° or 180°.

As illustrated in FIGS. 10 through 13, there is a tendency that luminance is higher in the slant direction than in the normal direction in each of the samples, and that whitening is generated in at slant viewing angle. The whitening refers to a phenomenon that if a relatively dark display of low gradation is presented, that display that should look dark with the viewing angle made slant from the normal direction actually looks somewhat white. The γ shift became smaller as the difference between the voltage supplied to the lower-layer electrode 61 and the voltage supplied to the upper-layer electrode 63 increased.

Three samples as combinations of the sample 1 and the sample 4 giving the large difference in the VT curves were calculated. In a sample 5, an area ratio of the pixels of the sample 1 to the pixels of the sample 4 was set to be 1:1. In a sample 6, an area ratio of the pixels of the sample 1 to the pixels of the sample 4 was set to be 1:2. In a sample 7, an area ratio of the pixels of the sample 1 to the pixels of the sample 4 was set to be 1:3.

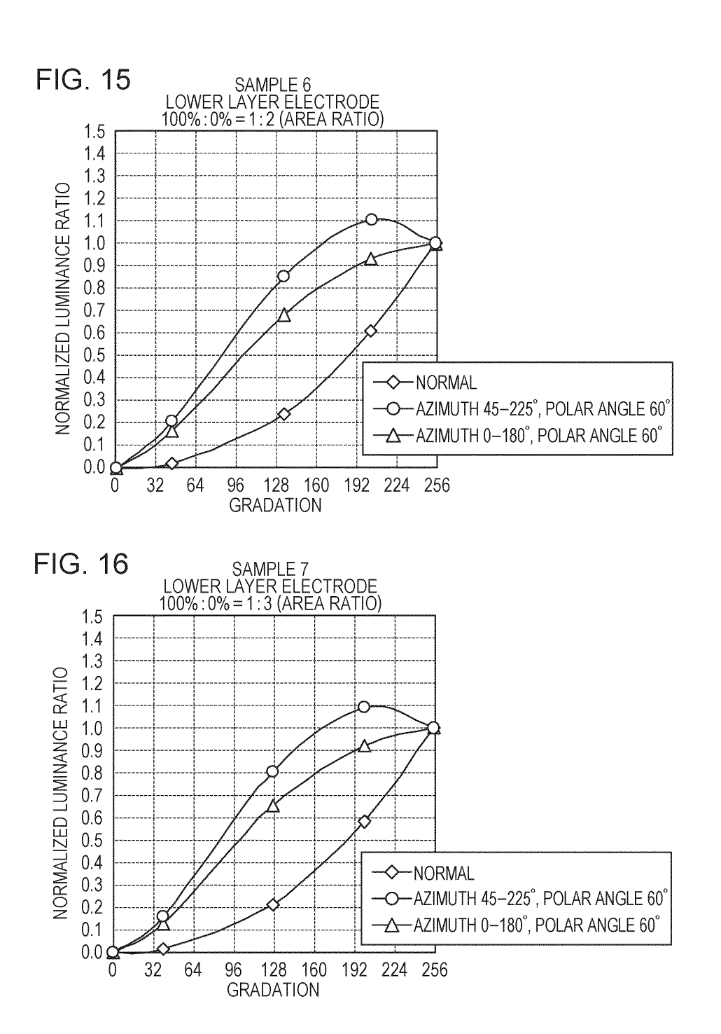

FIGS. 14 through 16 illustrate γ shifts of the samples 5 through 7 determined in the simulation test. In FIGS. 14 through 16, the abscissa represents gradation and the ordinate represents a normalized luminance ratio. In FIGS. 14 through 16, each plot is corrected with γ=2.2. FIGS. 14 through 16 illustrates results in the normal direction, in the direction of a polar angle 60° and an azimuth angle of 45° or 225°, and in the direction of a polar angle 60° and an azimuth angle of 0° or 180°.

Referring to FIGS. 14 through 16, an increase in luminance at a low gradation was set to be smaller in the samples 5 through 7 than in the samples 1 through 4. Specifically, the samples 5 through 7 improved the γ shift.

The results of the above simulation test indicated that the liquid-crystal panel 100 of the first embodiment having the regions R1 and R2 different in TV curve improved the γ shift.

The upper-layer electrode 20 and the lower-layer electrode 22 are provided with the same voltage responsive to the image signal. For this reason, when the upper-layer electrode 20 is supplied with a maximum drive voltage, in other words, when the liquid-crystal panel 100 gives a white display (maximum gradation), the potential of the upper-layer electrode 20 becomes equal to the potential of the lower-layer electrode 22. Specifically, the region R1 works in the same manner as that in the sample 4. The transmittance at the region where the lower-layer electrode 22 is disposed is increased, and as a result, the transmittance of the entire picture element is increased. Also, white luminance is increased.

The results of the simulation test also indicated that the γ shift was improved by varying the area ratio of the pixels of the sample 1 and the pixels of the sample 4. The area ratio of the region R1 to the region R2 may be appropriately set in the liquid-crystal panel 100 of the first embodiment. For example, the area ratio of the region R1 to the region R2 may be set to somewhere between 1:1 and 1:3.

### Second Embodiment

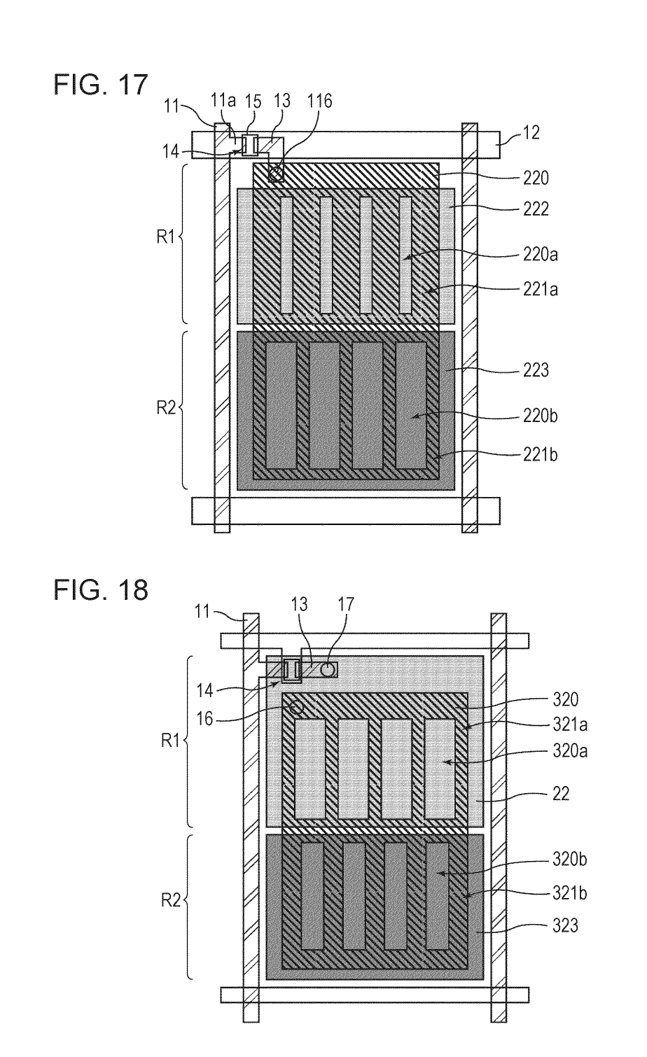

As illustrated in FIG. 17, the liquid crystal display of a second embodiment is substantially identical to the liquid-crystal display of the first embodiment except that the upper-layer electrode 20 and the lower-layer electrodes 22 and 23 are respectively replaced with an upper-layer electrode 220, and lower-layer electrodes 222 and 223. The present embodiment is slightly different from the first embodiment in the layout of the TFT 14, but the function thereof remains unchanged, and the discussion thereof is omitted herein.

The lower-layer electrodes 222 and 223 are arranged in each picture element, and respectively arranged in the regions R1 and R2. The lower-layer electrodes 222 and 223 are disposed in a lower-layer electrode layer. The upper-layer electrode 220 are disposed in the regions R1 and R2, namely, in the picture element so that the upper-layer electrode 220 are opposed to the lower-layer electrodes 222 and 223.

The upper-layer electrode 220 includes a plurality of mutually parallel slits 220a and a plurality of mutually parallel slits 20b. As a result, the upper-layer electrode 220 includes a plurality of line portions 221a that extend in parallel with each other with a spacing maintained therebetween and a plurality of line portions 221b that extend in parallel with each other with a spacing maintained therebetween. The slits 220a and 220b, and the line portions 221a and 221b extend generally in parallel with a source bus line 11 in the up-down direction. The slits 220a and the line portions 221a are arranged in the region R1 and the slits 220b and 221b are arranged in the region R2. The width of the slit 220a is narrower than the width of slit 220b. For this reason, an area A1 where the upper-layer electrode 220 is mutually opposed to (faces) the lower-layer electrode 222 is larger than an area A2 where the upper-layer electrode 220 is mutually opposed to (faces) the lower-layer electrode 223.

The upper-layer electrode 220 is electrically connected to the drain electrode 13 of a TFT 14 via a contact hole 116 penetrating a second insulating layer 18 and a first insulating layer.

The TFT 14 turns on in response to an input of the scan signal and remains turned on for a constant period of time. While the TFT 14 remains turned on, the upper-layer electrode 220 is supplied with an image signal at a predetermined timing via the source bus line 11. In other words, the upper-layer electrode 220 is supplied with a voltage responsive to the image signal, and then functions as a pixel electrode.

On the other hand, each of the lower-layer electrodes 222 and 223 is electrically isolated from other conductive members (such as the upper-layer electrode 220, and the bus lines 11 and 12) and thus remains floating.

After the image signal is supplied, a capacitor C1 is generated between the upper-layer electrode 220 and the lower-layer electrode 222 in accordance with the area A1, dielectric constant ∈ of the second insulating layer 18, and a distance d1 between the two electrodes. The potential of a portion (hereinafter referred to as a first slit portion) of the lower-layer electrode 222 opposed to (facing) the slit 220a varies in accordance with the capacitance of the capacitor C1. Similarly, a capacitor C2 is generated between the upper-layer electrode 220 and the lower-layer electrode 223 in accordance with the area A2, dielectric constant ∈ of the second insulating layer 18, and a distance d2 between the two electrodes. The potential of a portion (hereinafter referred to as a second slit portion) of the lower-layer electrode 223 opposed to (facing) the slit 220b varies in accordance with the capacitance of the capacitor C2.

The first and second slit portions and the upper-layer electrode 220 have potentials of the same polarity. However, the voltage of the first and second slit portions is lower than the voltage of the upper-layer electrode 220.

The area A1 is different from the area A2, and the distance d1 and the distance d2 are approximately equal to each other. The capacitor C1 and the capacitor C2 thus become different in capacitance from each other, and the potential of the first slit portion and the potential of the second slit portion also become different from each other.

A difference is thus caused between a voltage pulled into the first slit portion (pull-in voltage) and a voltage pulled into the second slit portion (pull-in voltage). As a result, the voltage driving the liquid crystal layer 3 becomes different from the region R1 to the region R2 and the distribution of the electric field becomes different from the region R1 to the region R2. The VT curve also becomes different from the region R1 to the region R2. The viewing angle characteristics (such as the γ shift) are thus improved.

It is noted that a storage capacitor is formed in the second insulating layer 18 between the upper-layer electrode 220 and the lower-layer electrode 222, and a storage capacitor is formed in second insulating layer 18 between the upper-layer electrode 220 and the lower-layer electrode 223 in the present embodiment.

### Third Embodiment

As illustrated in FIG. 18, the liquid crystal display of a third embodiment is identical to the liquid-crystal display of the first embodiment except that the upper-layer electrode 20 and the lower-layer electrode 23 are respectively replaced with an upper-layer electrode 320 and a lower-layer electrode 323. In other words, the liquid-crystal display of the third embodiment includes the lower-layer electrode 22.

The lower-layer electrode 323 is arranged in each picture element, and is thus arranged in the region R2. The lower-layer electrode 323 is disposed in the lower-layer electrode layer. The upper-layer electrode 320 is arranged in the regions R1 and R2, namely, in the picture element so that the upper-layer electrode 320 is opposed to the lower-layer electrodes 22 and 323.

The upper-layer electrode 320 includes a plurality of mutually parallel slits 320a and a plurality of mutually parallel slits 320b. As a result, the upper-layer electrode 320 includes a plurality of line portions 321a that extend in parallel with each other with a spacing maintained therebetween and a plurality of line portions 321b that extend in parallel with each other with a spacing maintained therebetween. The slits 320a and 320b, and the line portions 321a and 321b extend generally in parallel with a source bus line 11 in the up-down direction. The slits 320a and the line portions 321a are arranged in the region R1 and the slits 320b and the line portions 321b are arranged in the region R2. The width of the slit 320a is wider than the width of slit 320b.

The upper-layer electrode 320 is electrically connected to the lower-layer electrode 22 via a contact hole 116 arranged in the second insulating layer 18, and the lower-layer electrode 22 is electrically connected to the drain electrode 13 of the TFT 14 via a contact hole 17 arranged in the first insulating layer. In the same manner as in the first embodiment, the upper-layer electrode 320 and the lower-layer electrode 22 are supplied with a voltage responsive to the image signal, and thus serve as pixel electrodes.

On the other hand, the lower-layer electrode 323 is electrically isolated from other conductive members (such as the upper-layer electrode 320, and the bus lines 11 and 12) and thus remains floating.

After the image signal is supplied, a capacitor C3 is formed between the upper-layer electrode 320 and the lower-layer electrode 323 in accordance with an area A3 of a portion where the upper-layer electrode 320 and the lower-layer electrode 323 is opposed to (faces) each other, dielectric constant ∈ of the second insulating layer 18, and a distance d3 between the two electrodes. The potential of a portion (hereinafter referred to as a slit portion of the lower-layer electrode 323) of the lower-layer electrode 323 opposed to (facing) the slit 320b (hereinafter referred to as a slit portion of the lower-layer electrode 323) varies in accordance with the capacitance of the capacitor C3.

The slit portion of the lower-layer electrode 323 and the upper-layer electrode 320 have potentials of the same polarity. However, the voltage of the slit portion of the lower-layer electrode 323 is lower than the voltage of the upper-layer electrode 320.

A difference is thus caused between a voltage (pull-in voltage) pulled into a portion of the lower-layer electrode 22 opposed to (facing) the slit 320a and a voltage (pull-in voltage) pulled into the slit portion of the lower-layer electrode 323. As a result, the voltage driving the liquid crystal layer 3 becomes different from the region R1 to the region R2 and the distribution of the electric field becomes different from the region R1 to the region R2. The VT curve also becomes different from the region R1 to the region R2. The viewing angle characteristics (such as the γ shift) are thus improved.

In the present embodiment, a storage capacitor is formed in the second insulating layer 18 between the upper-layer electrode 320 and the lower-layer electrode 323.

The upper-layer electrode 320 and the lower-layer electrode 22 are supplied with a voltage responsive to the image signal. For this reason, in the same manner as in the first embodiment, the transmittance of the entire picture element is increased. The white luminance is also increased.

### Fourth Embodiment

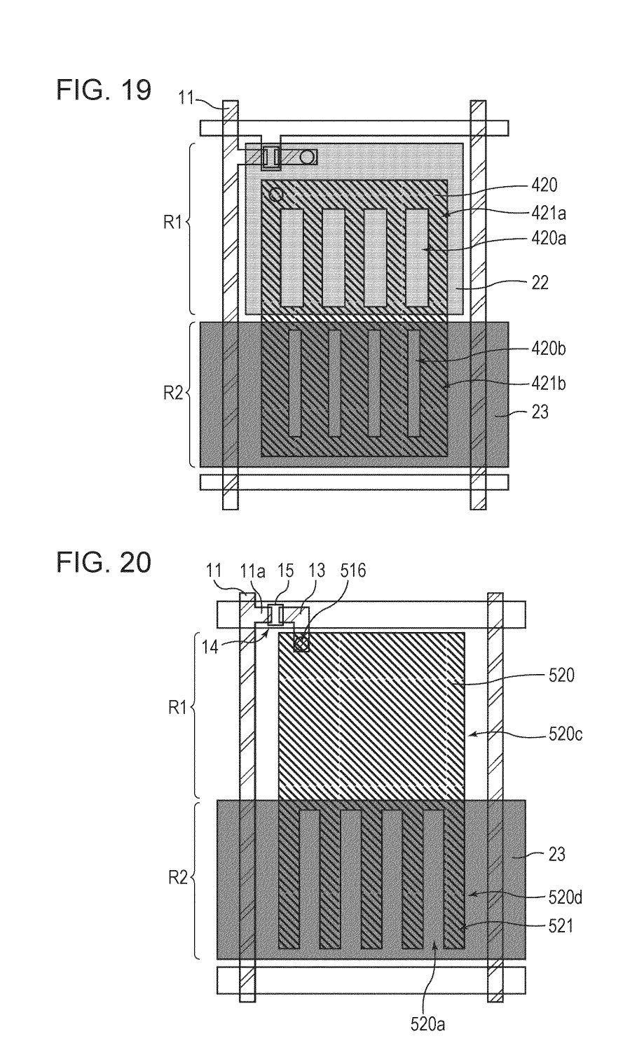

As illustrated in FIG. 19, the liquid crystal display of a fourth embodiment is substantially identical to the liquid-crystal display of the first embodiment except that the upper-layer electrode 20 is replaced with an upper-layer electrode 420. In other words, the liquid-crystal display of the fourth embodiment includes the lower-layer electrodes 22 and 23.

The upper-layer electrode 420 is arranged in the regions R1 and R2, namely, in a picture element region so that the upper-layer electrode 420 is opposed to the lower-layer electrodes 22 and 23.

The upper-layer electrode 420 includes a plurality of mutually parallel slits 420a and a plurality of mutually parallel slits 420b. As a result, the upper-layer electrode 420 includes a plurality of line portions 421a that extend in parallel with each other with a spacing maintained therebetween and a plurality of line portions 421b that extend in parallel with each other with a spacing maintained therebetween. The slits 420a and 420b, and the line portions 421a and 421b extend generally in parallel with a source bus line 11 in the up-down direction. The slits 420a and the line portions 421a are arranged in the region R1 and the slits 420b and 421b are arranged in the region R2. The width of the slit 420a is wider than the width of slit 420b.

In accordance with the same principle of the first embodiment, in the present embodiment, the voltage driving the liquid crystal layer 3 becomes different from the region R1 to the region R2 and the distribution of the electric field becomes different from the region R1 to the region R2. The VT curve also becomes different from the region R1 to the region R2. The viewing angle characteristics (such as the γ shift) are thus improved.

In the present embodiment, a storage capacitor is formed between in the second insulating layer 18 between the upper-layer electrode 420 and the lower-layer electrode 23.

The upper-layer electrode 420 and the lower-layer electrode 22 are supplied with a voltage responsive to the image signal. For this reason, in the same manner as in the first embodiment, the transmittance of the entire picture element is increased. The white luminance is also increased.

### Fifth Embodiment

As illustrated in FIG. 20, the liquid crystal display of a fifth embodiment is substantially identical to the liquid-crystal display of the first embodiment except that the upper-layer electrode 20 is replaced with an upper-layer electrode 520 and that there is no lower-layer electrode 22. In other words, in the fifth embodiment, the lower-layer electrode 22 is not disposed in the lower-layer electrode layer, but only the lower-layer electrode 23 is disposed in the lower-layer electrode layer. The present embodiment is slightly different from the first embodiment in the layout of the TFT 14, but the function thereof remains unchanged, and the discussion thereof is omitted herein.

The upper-layer electrode 520 is arranged in the regions R1 and R2, namely, in the picture element region so that the upper-layer electrode 520 is opposed to the lower-layer electrode 23.

The upper-layer electrode 520 includes a planar portion (plane portion) 520c, and a tooth-like portion (tooth portion) 520d. The plane portion 520c is a portion having no seam, and arranged in the region R1. The tooth portion 520d is arranged in the region R2 so that the tooth portion 520d is opposed to the lower-layer electrode 23. The tooth portion 520d has a plurality of mutually parallel slits 520a. As a result, the upper-layer electrode 520 includes a plurality of line portions 521 that are arranged in parallel to each other with a spacing maintained therebetween. The end of each slit 520a opposite the side of the plane portion 520c is opened. The slits 520a, and the line portions 521 extend in the up-down direction substantially in parallel with the source bus line 11.

The upper-layer electrode 520 is electrically connected to the drain electrode 13 of the TFT 14 via a contact hole 516 that penetrates the second insulating layer 18 and the first insulating layer.

The TFT 14 turns on in response to an input of the scan signal and remains turned on for a constant period of time. While the TFT 14 remains turned on, the upper-layer electrode 520 is supplied with an image signal at a predetermined timing via the source bus line 11. In other words, the upper-layer electrode 520 is supplied with a voltage responsive to the image signal, and then functions as a pixel electrode.

On the other hand, the lower-layer electrode 23 is supplied with a predetermined DC voltage (0 V, for example).

After the image signal is supplied, a voltage pulled into the lower-layer electrode 23 (pull-in voltage) is generated in the region R2. On the other hand, only the plane portion 520c is disposed in the region R1, and no pull-in voltage is generated in the region R1. As a result, the voltage driving the liquid crystal layer 3 becomes different from the region R1 to the region R2 and the distribution of the electric field becomes different from the region R1 to the region R2. The VT curve also becomes different from the region R1 to the region R2. The viewing angle characteristics (such as the γ shift) are thus improved.

In the present embodiment, a storage capacitor is formed in the second insulating layer 18 between the upper-layer electrode 520 and the lower-layer electrode 23.

Since the area having the plane portion 520c arranged thereon is brightened, the transmittance is increased.

The one end of the slit 520a is opened. For this reason, the orientations of the overturns of the liquid crystal molecules are aligned. This prevents an alignment fault in the liquid crystal molecules from being generated on the slit 520a.

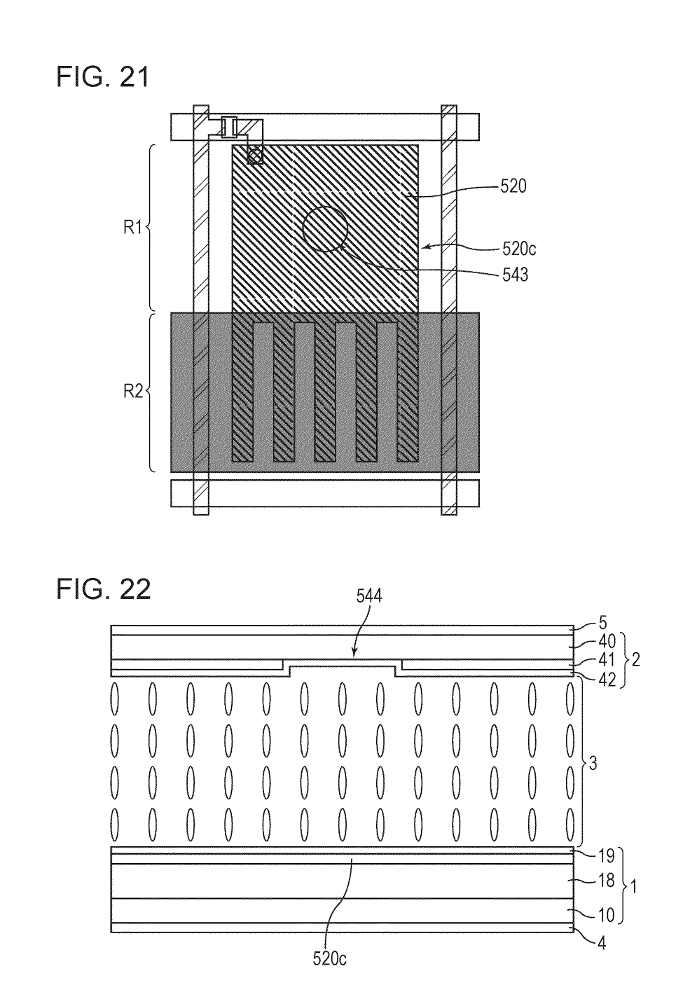

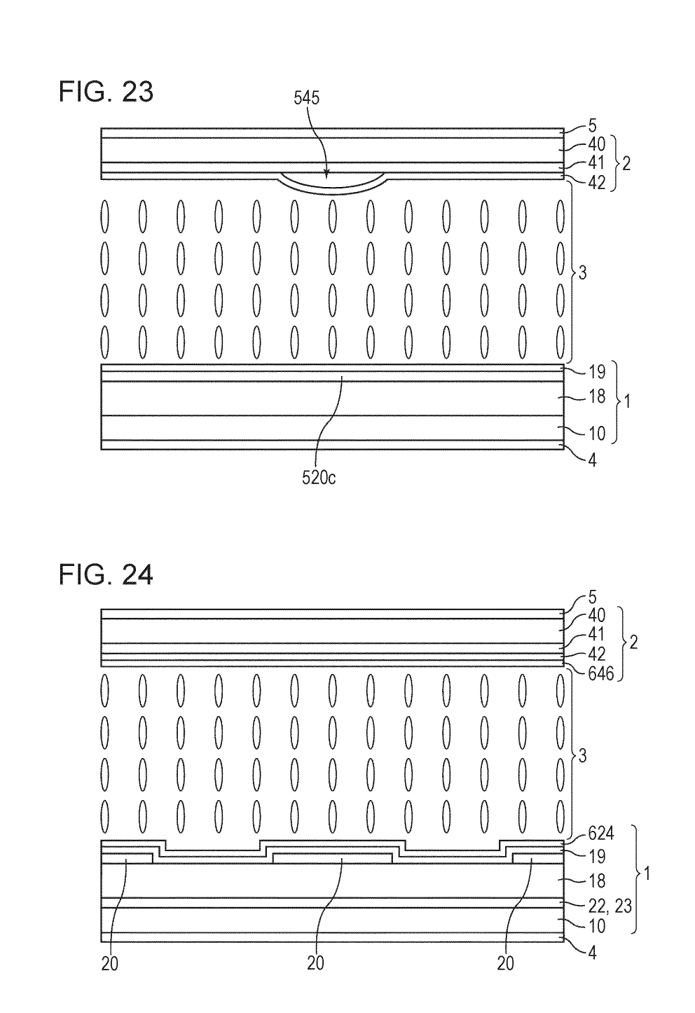

FIG. 21 is a plan view diagrammatically illustrating a first modification of the liquid crystal display of the fifth embodiment. FIG. 22 is a sectional view diagrammatically illustrating a second modification of the liquid crystal display of the fifth embodiment. FIG. 23 is a sectional view diagrammatically illustrating a third modification of the liquid crystal display of the fifth embodiment.

As illustrated in FIG. 21, the substrate 2 may include an alignment anchoring structure 543 facing the plane portion 520c. In this way, the stability of the alignment of the liquid crystal molecules may be increased. The alignment anchoring structure 543 restricts the direction of tilt of the liquid crystal molecules in response to the application of voltage, and is arranged in a dotted layout.

As illustrated in FIG. 22, an opening 544 is formed in the counter electrode 41 so that the opening 544 serves as the alignment anchoring structure 543.

As illustrated in FIG. 23, a projection 545 is formed on the counter electrode 41 so that the projection 545 serves as the alignment anchoring structure 543.

### Sixth Embodiment

As illustrated in FIG. 24, the liquid-crystal display of a sixth embodiment is identical to the liquid-crystal display of the first embodiment except that the vertical alignment film 19 and the vertical alignment film 42 respectively include an alignment assisting layer 624 and an alignment assisting layer 646.

According to the present embodiment, the stability of the alignment of the liquid crystal molecules is increased. A change in luminance caused by pressure of a member such as a touchpen is decreased.

The alignment assisting layers 624 and 646 are disposed through an alignment sustaining technique using polymer, so-called PSA (Polymer Sustained Alignment). Specifically, a composition containing a liquid crystal material mixed with a polymerization component such as monomer or oligomer is inserted to fill between the substrates 1 and 2. With the electrodes supplied with predetermined voltages, the polymerization component is polymerized by heating the polymerization component and/or irradiating the polymerization component with light (such as ultraviolet light). In this way, the alignment assisting layers 624 and 646 containing the polymer are formed. With no voltage applied, the liquid crystal molecules have a predetermined pretilt angle with the alignment azimuth of the liquid crystal molecules controlled. The polymerization of the polymerization component may be performed with no voltage applied.

The inventors actually manufactured the liquid-crystal display of the present embodiment and confirmed that a change in luminance caused by pressure of a member such as a touchpen was reduced.

### Seventh Embodiment

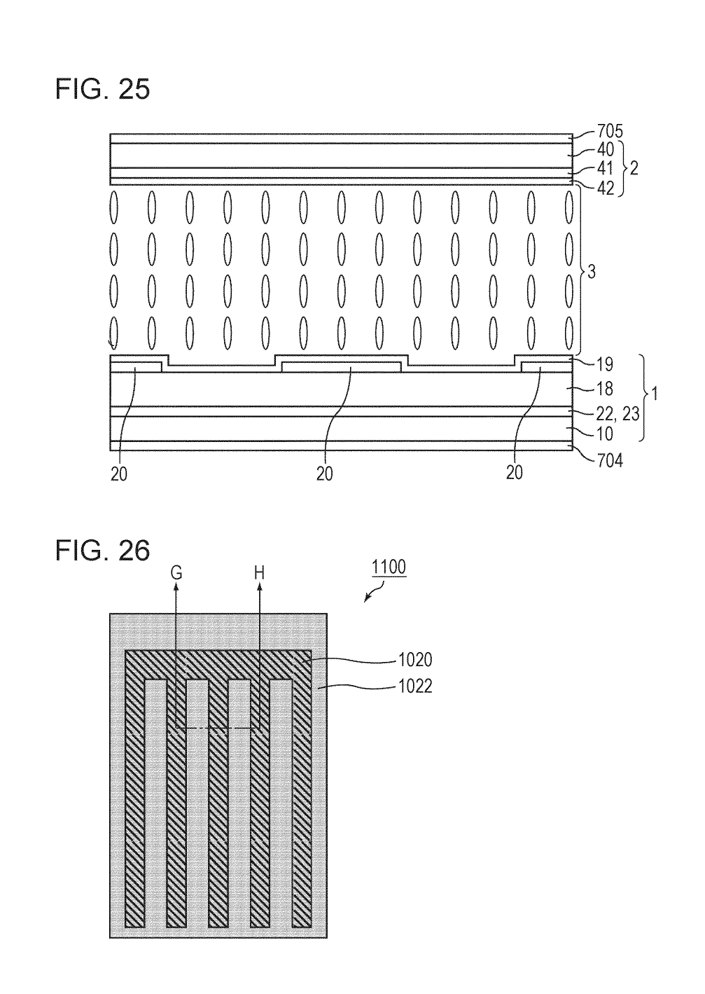

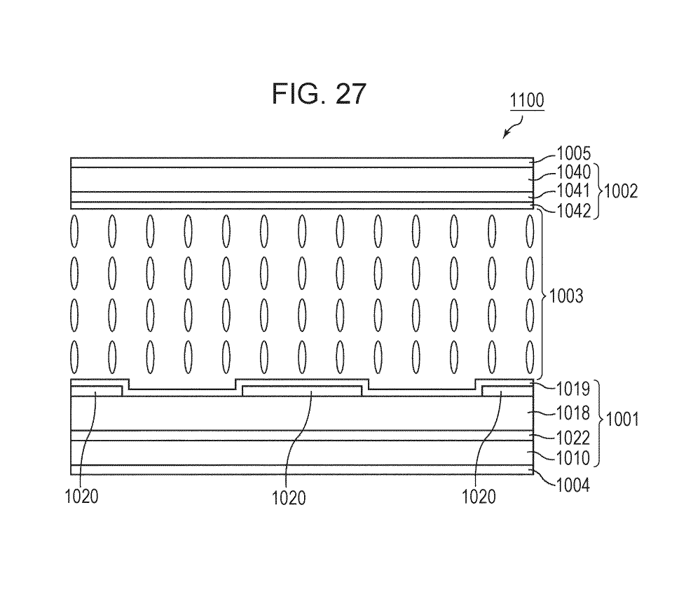

As illustrated in FIG. 25, the liquid-crystal display of a seventh embodiment is identical to the liquid-crystal display of the first embodiment except that the circularly polarizing plates 4 and 5 are replaced with linear polarizing plates 704 and 705.

The linear polarizing plates 704 and 705 are crossed Nichol arranged to each other. More specifically, the absorption axes of the linear polarizing plates 704 and 705 are substantially perpendicular to each other. The absorption axes of the linear polarizing plates 704 and 705 are respectively set to be an azimuth angle of 45° and an azimuth angle of 135°.

Each of the linear polarizing plates 704 and 705 include a linear polarizing element. The linear polarizing element is typically manufactured by causing a polyvinyl alcohol (PVA) film to absorb an anisotropic material, such as dichroic iodine complex, and aligning the film. To ensure mechanical strength and heat and humidity resistance, each of the linear polarizing plates 704 and 705 further includes a protective film. The protective film is typically a triacetylcellulose (TAC) film that is laminated on both surfaces of the PVA films through an adhesion layer.

According the present embodiment, the viewing angle characteristics are even further improved.

The embodiments may be combined appropriately without departing from the scope of the present invention. For example, in the same manner as in the fifth embodiment, the one end of the slit may be opened and the upper-layer electrode may have the comb portion in each of the first through fourth embodiments.

In each of the above embodiments, the number of regions that are different in terms of the voltage driving the liquid crystal layer 3 and/or the distribution of electric field is not limited to two. Three regions or more may be used. For example, like the upper-layer electrode 520 of the fifth embodiment, a planar portion may be added to the lower-layer electrode 22 of the first embodiment. In such a case, the picture element may include three regions that are different in terms of the voltage driving the liquid crystal layer 3 and/or the distribution of electric field.

The present patent application claims priority recognized under the Paris Convention and the rules of each designated state based on Japanese Patent Application 2010-293847 that was filed on Dec. 28, 2010. The contents of the application are hereby incorporated by reference in their entirety in the present patent application.

### REFERENCE SIGNS LIST

1 Active matrix substrate
2 Counter substrate
3 Liquid crystal layer
4 and 5 Circularly polarizing plates
10 and 40 Insulating substrates
11 Source bus line
11a Source electrode
12 Gate bus line
12a Gate electrode
13 Drain electrode
14 TFT
15 Semiconductor layer
16 and 17 Contact holes
18 Second insulating layer
19 and 42 Vertical alignment films
20 Upper-layer electrode
20a Slit
21 Line portion
22 and 23 Lower-layer electrodes
41 Counter electrode
100 Liquid crystal panel
R1 and R2 Regions
d Cell gap
L and S Widths

1. A liquid crystal panel comprising a first substrate, a second electrode opposed to the first substrate, and a liquid crystal layer interposed between the first substrate and the second substrate,
wherein the first substrate includes a first electrode and a second electrode,
wherein the second substrate includes a third electrode,
wherein the liquid crystal layer is driven by an electric field generated at least by the first electrode, the second electrode, and the third electrode, and
wherein the liquid crystal panel includes within a pixel a plurality of regions that are supplied with different voltages to drive the liquid crystal layer.

2. The liquid crystal panel according to claim 1, wherein the first electrode comprises a plurality of line portions.

3. The liquid crystal panel according to claim 1, wherein the second electrode is planer.

4. The liquid crystal panel according to claim 1, wherein the third electrode is at least opposed to the first electrode.

5. The liquid crystal panel according to claim 1, wherein the third electrode is planer.

6. The liquid crystal panel according to claim 1, wherein the first substrate further comprises an insulating layer between the first electrode and the second electrode.

7. (canceled)

8. The liquid crystal panel according to claim 1, wherein the first electrode is a pixel electrode, and
wherein the third electrode is a common electrode.

9. The liquid crystal panel according to claim 1, wherein the first substrate further comprises a fourth electrode, and
wherein the liquid crystal layer is driven by an electric field generated at least by the first electrode, the second electrode, the third electrode, and the fourth electrode.

10. (canceled)

11. (canceled)

12. (canceled)

13. The liquid crystal panel according to claim 9, wherein a potential of the second electrode is different in level from a potential of the fourth electrode in a state in which the first electrode is supplied with a voltage.

14. (canceled)

15. (canceled)

16. (canceled)

17. The liquid crystal panel according to claim 13, wherein the second electrode and the fourth electrode are floating electrodes.

18. The liquid crystal panel according to claim 17, wherein a first capacitor is formed between the first electrode and the second electrode,
wherein a second capacitor is formed between the first electrode and the fourth electrode, and
wherein the first capacitor is different in capacitance from the second capacitor.

19. (canceled)

20. (canceled)

21. (canceled)

22. The liquid crystal panel according to claim 13, wherein the first electrode comprises a plurality of first line portions arranged side by side with a spacing maintained therebetween, and a plurality of second line portions arranged side by side with a spacing maintained therebetween,
wherein the first line portions are arranged within a first region of the plurality of regions,
wherein the second line portions are arranged within a second region of the plurality of regions, and
wherein the spacing between the first line portions is wider than the spacing between the second line portions.

23. (canceled)

24. (canceled)

25. (canceled)

26. The liquid crystal panel according to claim 1, wherein the liquid crystal panel is a vertical alignment type liquid crystal panel.

27. The liquid crystal panel according to claim 1, wherein the liquid crystal layer comprises liquid crystal molecules having a negative anisotropy of dielectric constant.

28. The liquid crystal panel according to claim 1, further comprising a circularly polarizing plate.

29. The liquid crystal panel according to claim 1, further comprising a linear polarizing plate.

30. (canceled)

31. (canceled)

32. The liquid crystal panel according to claim 1, wherein the second substrate comprises an alignment anchoring structure.

33. The liquid crystal panel according to claim 32, wherein the alignment anchoring structure is an aperture formed in the third electrode.

34. (canceled)

35. A liquid crystal display comprising the liquid crystal panel according to claim 1.

36. A liquid crystal panel comprising a first substrate, a second electrode opposed to the first substrate, and a liquid crystal layer interposed between the first substrate and the second substrate,
wherein the first substrate includes a first electrode and a second electrode,
wherein the second substrate includes a third electrode,
wherein the liquid crystal layer is driven by an electric field generated at least by the first electrode, the second electrode, and the third electrode, and
wherein the liquid crystal panel includes within a pixel a plurality of regions that are different in distribution of the electric field.

37. (canceled)
